(19) United States
(12) Patent Application Publication
(10) Pub. No.: US 2014/0063807 A1
(43) Pub. Date: Mar. 6, 2014

(54) LIGHT EMITTING STRUCTURE AND LIGHTING UNITS THEREOF

(71) Applicant: Yi-Sho Liang, Taipei City (TW)

(72) Inventor: Yi-Sho Liang, Taipei City (TW)

(21) Appl. No.: 13/666,169

(22) Filed: Nov. 1, 2012

(30) Foreign Application Priority Data
Aug. 29, 2012 (TW) 101216595

(51) Int. Cl. F21V 21/00

(52) U.S. Cl. 362/249.02

(57) ABSTRACT

A lighting unit includes a base and light emitting elements. At least a pin is disposed at the top of the base, and the light emitting units are provided on and electrically connected to the pin. At least a conductive hole is formed at a location in the base corresponding to the pin for communicating with the top and the bottom of the base. Also, a plurality of the lighting units are integrally arranged to form a light emitting structure.

### BACKGROUND OF THE INVENTION

1. Field of the Invention

The present invention relates to lighting units, and, more particularly, to lighting units that arbitrary form various kinds of light emitting structures.

2. Description of Related Art

The rapid development of light emitting diodes (LED) in recent years has gradually replaced many traditional lighting fixtures, such as tungsten light, incandescent light, fluorescent and spotlight, mainly due to their low power consumption and remarkable performances in brightness, color, and switching speed. Therefore, LEDs are particularly useful when applied to indoor or outdoor lighting or traffic signals for providing guidance.

As shown in FIG. 1, ROC Patent No. M382553 provides a technique for using LEDs as billboards, which involves first drilling a plurality of through holes 100 at equal intervals on a square panel 10, and then inserting LEDs 11 into these through holes 100 so as to arrange a desired text or pattern.

However, in the conventional approach of using LEDs as billboards, the area and the shape of the panel 10 are fixed, such that the number of LEDs 11 are limited by the fixed number of through holes 100. If the number of through holes 100 is insufficient, then the LEDs 11 cannot present the desired text or pattern.

In order to present better or great diversity of patterns or texts, more through holes 100 are needed, and so is the area of the panel 10 accordingly. But the applicability of the panel 10 to the environment to be installed with the panel must now be considered, for example, whether a large panel 10 will affect the environment to be installed with the panel.

In addition, if the panel 10 is installed on an uneven surface (such as a building), the panel 10 will cover the uneven surface and makes it impossible to render the original uneven surface features, thus affecting the original appearance of the structure.

Therefore, how to overcome these problems of the prior art as mentioned before has become an urgent issue to be resolved.

### SUMMARY OF THE INVENTION

In light of the foregoing drawbacks, the present invention provides lighting units that can arbitrarily form various kinds of light emitting structures. The lighting unit includes a base having a first side and a second side opposite to the first side, at least a pin formed at the first side, at least a conductive hole formed at a location in the base corresponding to the pin for communicating with the first side and the second side of the base, and at least a light emitting element provided on and electrically connected to the pin.

Moreover, the present invention further provides a light emitting structure including a plurality of the lighting units integrally arranged. In an embodiment, the lighting units are engaged with each other in a way that the pin of one of the lighting units is inserted into the conductive hole of another one of the lighting units.

It can be seen from the above that the lighting units of the present invention can be assembled into the light emitting structure of different shapes, that is, assembled into desired texts or patterns, with the design of the pin and the conductive hole, without the need to install the light emitting elements on a traditional panel. Therefore, the light emitting structure of the present invention is not limited to any external environment. Therefore, the lighting unit of the present invention can form a predetermined light emitting structure, and also reduce the volume of the light emitting structure suitable to the environment to which it is installed or directly form a part of the environment to which it is installed.

### BRIEF DESCRIPTION OF THE DRAWINGS

The present invention can be more fully understood by reading the following detailed description of the preferred embodiments, with reference made to the accompanying drawings, wherein:

FIG. 1 is schematic diagram depicting a perspective view of a conventional LED billboard;

FIGS. 2A and 2B are schematic diagrams depicting perspective views of a lighting unit in accordance with the present invention; and

FIGS. 3-6 are schematic diagrams depicting perspective views of light emitting structures in accordance with different embodiments of the present invention.

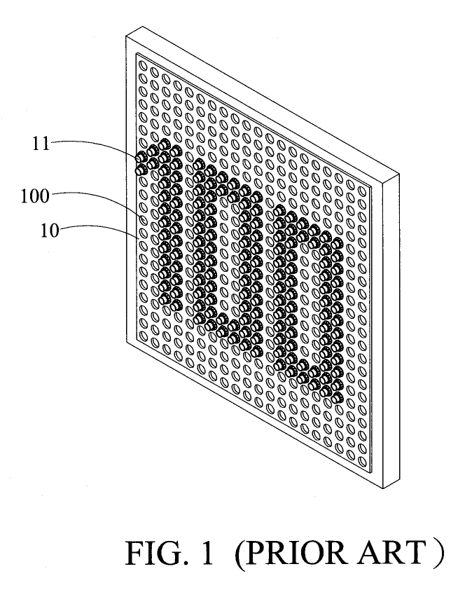

### DETAILED DESCRIPTION OF THE EMBODIMENTS

The present invention is described by the following specific embodiments. Those with ordinary skills in the arts can readily understand the other advantages and functions of the present invention after reading the disclosure of this specification.

It should be noted that the structures, proportions, sizes and the like shown in the attached drawings are to be considered only in conjunction with the contents of this specification to facilitate understanding and reading of those skilled in the art, and are not intended to limit the scope of present invention, thus they do not hold any real technically significance, and any changes or modifications in the structures, the proportions, the sizes and the like should fall within the scope of the technical contents disclosed in the present invention as long as they do not affect the effects and the objectives achieved by the present invention. Meanwhile, terms, such as “above”, “below”, “top”, “bottom”, “first”, “second” and “a”, used in this specification are used for ease of illustration only, and not to limit the scope of the present invention, any changes or modifications of the relative relationships of elements are therefore to be construed as with the scope of the present invention as long as there is no substantial changes to the technical contents.

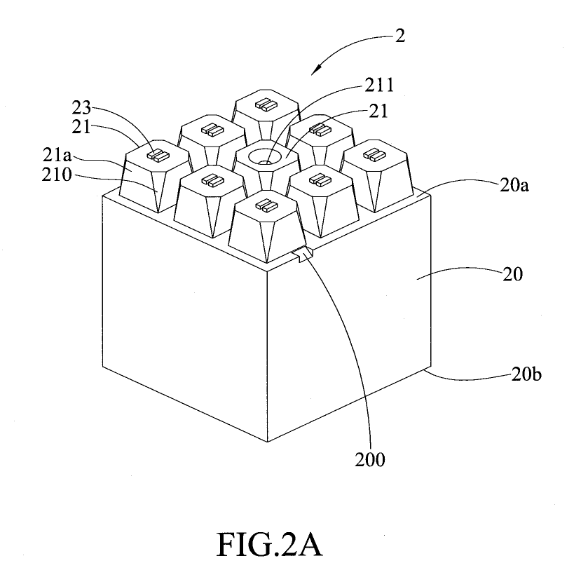

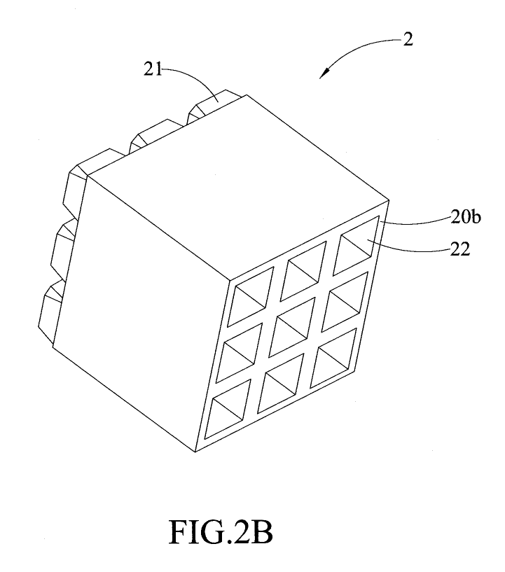

FIGS. 2A and 2B are schematic diagrams depicting perspective views of a lighting unit 2 in accordance with the present invention. The lighting unit 2 includes a base 20, a plurality of pins 21, a plurality of conductive holes 22, and a plurality of light emitting elements 23.

The base 20 is used as a foundation, which has a first side 20a and a second side 20b opposite to the first side 20a. The pins 21 are disposed on the first side 20a of the base 20.

The pins 21 are cylindrical and have sides 21a perpendicular to the first side 20a of the base 20. In an embodiment, chamfers 210 are disposed at the edges of the sides 21a of the each of the pins 21.

The conductive holes 22 communicates with the first side 20a and second side 20b of the base 20, and each of conductive holes 22 corresponds to the location of one of the pins 21.

The light emitting elements 23 are light emitting diodes (LEDs), and are provided on top of the pins 21.

In an embodiment, the first side 20a of the base 20 further includes an indentation 200, and the shape of the structure of the base 20 may be round, rectangular, cylindrical, plate-like or irregular, without particular limitation, however.

Furthermore, wire holes 211 penetrate the pins 21. The wire holes 211 are connected to the conductive holes 22 to allow wires (not shown) to be electrically connected to the light emitting elements 23 therethrough. In fact, recesses can be first formed at the top of the pins 21, and smaller line wire holes 211 are then formed at the bottom of the recesses.

Further, the pins 21 are arranged in a matrix with equal intervals between them, but the present invention is not limited to such an arrangement.

Moreover, the shape of the structure of the pins 21 may be round, rectangular, cylindrical, plate-like, or irregular; there is no particular limitation.

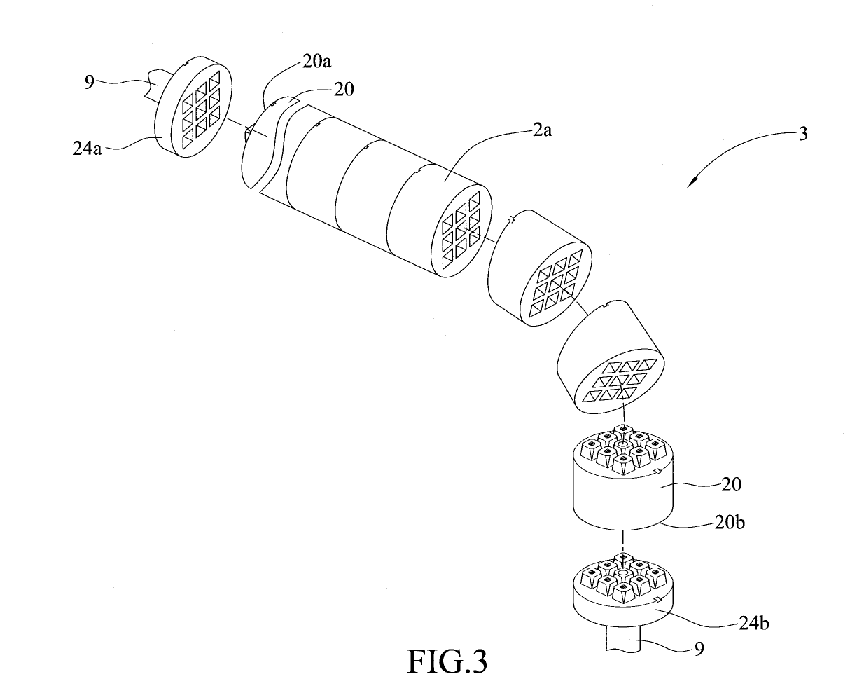

FIGS. 3-6 are schematic diagrams depicting perspective views of light emitting structures 3, 4, 5 and 6, respectively, in accordance with the present invention.

As shown in FIG. 3, a plurality of lighting units 2a are engaged with one another to form the light emitting structure 3 in such a way that the pins 21 of one of the lighting units 2a are inserted into the conductive holes 22 of another one of the lighting units 2a. In an embodiment, the light emitting structure 3 further includes cover plates 24a and 24b engaging the first side 20a and the second side 20b of the base 20 of the outermost light emitting units 2a, respectively, and are used as power terminals of an external wire 9.

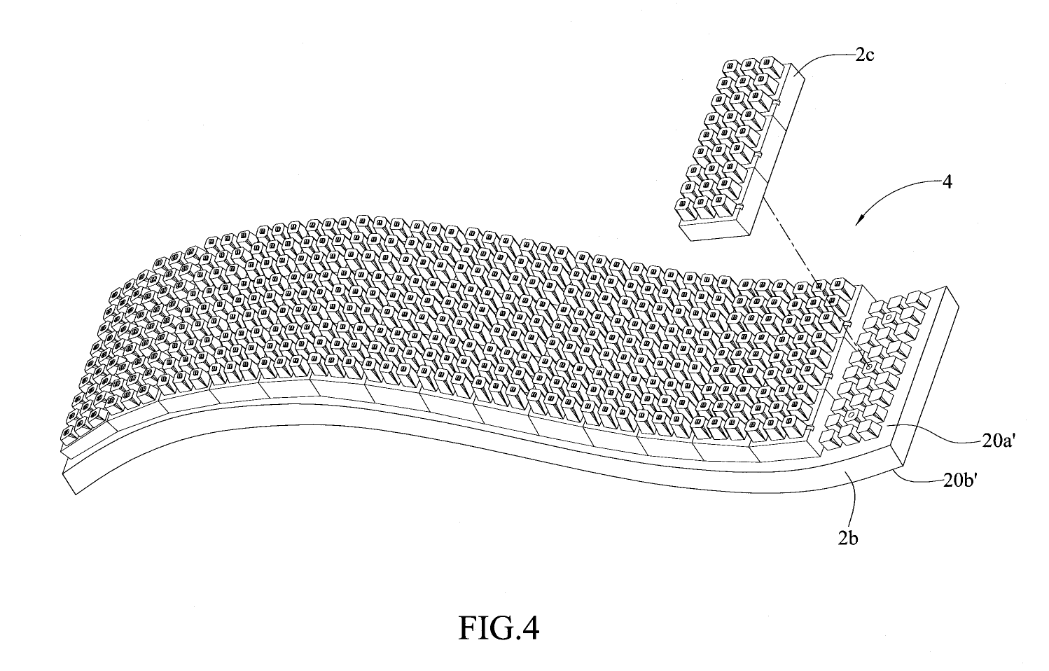

As shown in FIG. 4, the light emitting structure 4 is formed by docking a plurality of smaller lighting units 2c on a larger lighting unit 2b. The first side 20a′ and the second side 20b′ of the base 20 of the larger lighting unit 2b are curved surface, such that the light emitting structure 4 has a wave-like shape.

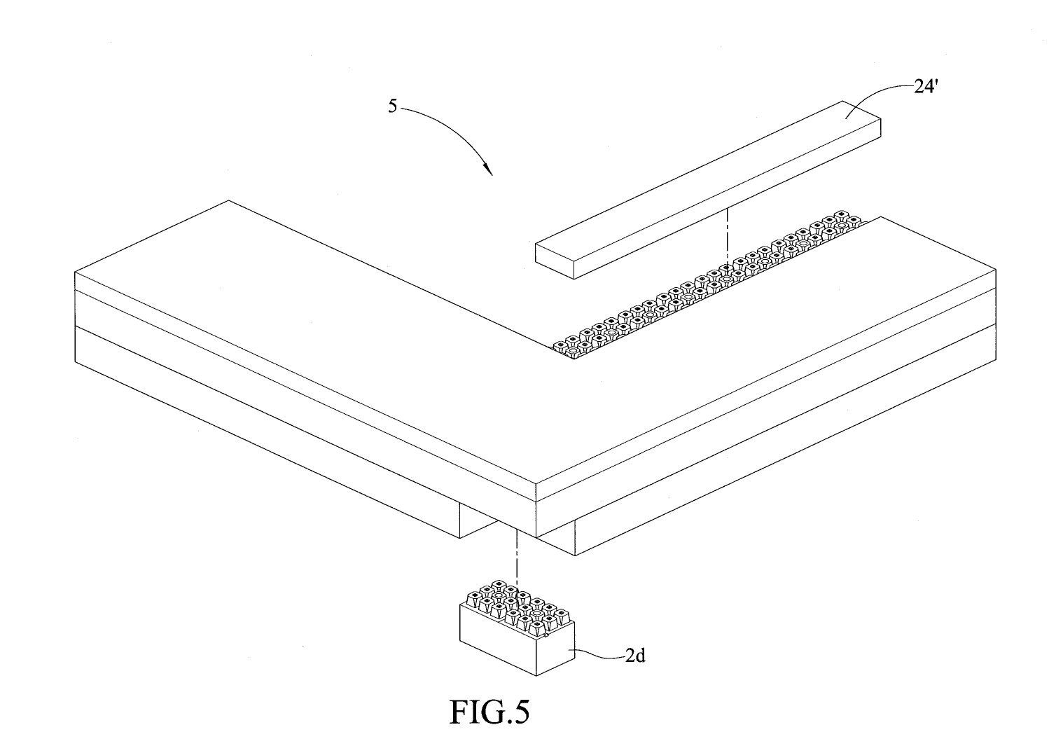

As shown in FIG. 5, the light emitting structure 5 is formed by stacking a plurality of lighting units 2d together into an L-shaped wall with a plurality of cover plates 24′ attached to the first side 20a of the base 20 of the topmost lighting unit 2d. In an embodiment, the light emitting elements 23 of the light emitting structure 5 can be used as decoration, illumination and guidance, and can be readily combined, detached or changed in shape, which makes it suitable for building structures. Furthermore, the shape of the wall can be designed according to the specific needs, and is not limited to the above-mentioned “L” shape.

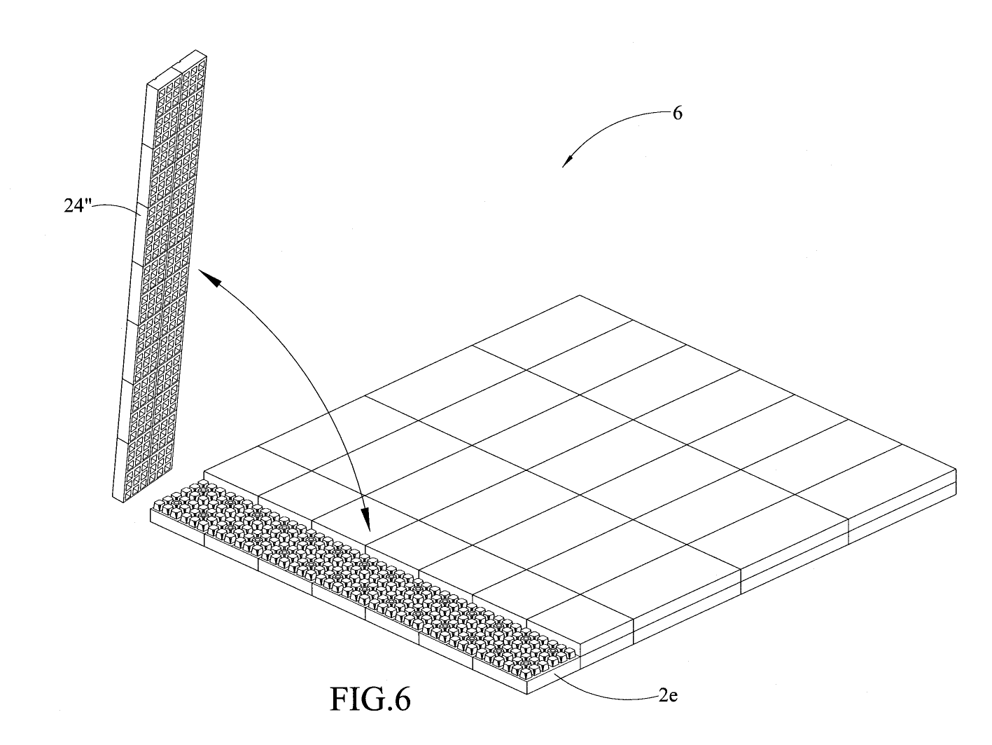

As shown in FIG. 6, the light emitting structure 6 is formed by placing a plurality of lighting units 2e in parallel to one another to form a plate body with a plurality of cover plates 24″ attached to the first side 20a of the base 20 of these lighting units 2e. In an embodiment, the light emitting structure 6 can be used as for home decoration, for example, Do-It-Yourself (DIY) floor or ceiling, and can be used as an emergency distress (lighting) board, such as a kickboard during flooding. The plate-like light emitting structure can also be made by attaching a single piece of large light emitting unit to a corresponding cover plate, or by arranging a plurality of LEDs side by side in an upper and a lower layer.

Accordingly, the light emitting structures 3, 4, 5 and 6 according to the present invention are not limited by any external environment, and are not limited by conventional panels. The light emitting structures 3, 4 5 and 6 can effectively present a predetermined structure, for example, in the case of the light emitting structure 3 shown in FIG. 3, or directly form a part of the environment to which they are installed, such as in the cases of light emitting structure 5 and 6 shown in FIGS. 5 and 6.

Furthermore, if texts or patterns are to be formed on a flat, uneven or curved surface, the light emitting structures 4, 5 and 6 can be used on the surfaces. Therefore, the lighting units 2b, 2c, 2d and 2e can be flexibly combined to form the light emitting structures 4, 5 and 6 having different shapes, and applied onto the structures of any walls or boards, making them practical and multi-functional.

Further, in the lighting units 2, 2a, 2b, 2c, 2d and 2e, based on demands, the light emitting elements 23 can be provided on some of the pins 21, or the light emitting elements 23 can be provided on all of the pins 21, or no light emitting element 23 is provided on the pins 21.

In an embodiments of the light-emitting structures 3, 4, 5 and 6, when each of the lighting units 2a, 2b, 2c, 2d and 2e is attached to the corresponding cover plate 24a, 24b, 24 and 24″, the cover plate 24a, 24b, 24 and 24″ has a concave or convex configuration that corresponds to the shape of the pins 21 or the conductive holes 22.

Furthermore, during docking, the sides 21a of the pins 21 are vertical as friction surfaces for increasing the friction between the pins 21 and the conductive holes 22, and the conductive holes 22 also serve as friction chamber for being engaged tightly with the pins 21 due to the principle of suction.

Moreover, during docking the indentation 200 serve as a convenient moment-exerting point when the pins 21 is detached from the conductive holes 22.

In addition, during docking and/or attachment, the chamfers 210 facilitate the discharge of excess air or fluid for each base 20.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A lighting unit, comprising:
a base including a first side and a second side opposite to the first side;
at least a pin formed at the first side of the base;
at least a conductive hole formed at a location in the base corresponding to the pin and communicating the first side with the second side of the base; and
at least a light emitting element provided on and electrically connected to the pin.

2. The lighting unit of claim 1, wherein the first side or the second side of the base has a curved face.

3. The lighting unit of claim 1, wherein the base further includes an indentation on the first side.

4. The lighting unit of claim 1, wherein the pin includes a wire hole penetrating therethrough for connecting the conductive hole.

5. The lighting unit of claim 1, wherein the pin has a side face perpendicular to the first side of the substrate.

6. The lighting unit of claim 1, wherein the pin includes at least one chamfer.

7. The lighting unit of claim 1, wherein the light emitting element is a light emitting diode (LED).

8. The lighting unit of claim 1, further comprising a cover plate attached to the first side or the second side of the base.

9. A light emitting structure, comprising a plurality of the lighting units of claim 1 integrally arranged together.

10. The light emitting structure of claim 9, wherein the lighting units are engaged with each other in a way that the pin of one of the lighting units is inserted into the conductive hole of another one of the lighting units.

11. The light emitting structure of claim 9, wherein the light emitting structure is a wall or a board.

12. The light emitting structure of claim 9, wherein the first side or the second side of the base has a curved face.

13. The light emitting structure of claim 9, wherein the first side of the base further includes an indentation.

14. The light emitting structure of claim 9, wherein the pin includes a wire hole penetrating therethrough for connecting the conductive hole.

15. The light emitting structure of claim 9, wherein the pin has a side face perpendicular to the first side of the substrate.

16. The light emitting structure of claim 9, wherein the pin includes at least one chamfer.

17. The light emitting structure of claim 9, wherein the light emitting element is an LED.

18. The light emitting structure of claim 9, further comprising a cover plate attached to the first side or the second side of the base.
